(19) United States
(12) Patent Application Publication
(10) Pub. No.: US 2025/0246764 A1
(43) Pub. Date: Jul. 31, 2025

(54) BUSBAR MODULE

(71) Applicant: Yazaki Corporation, Tokyo (JP)

(72) Inventors: Shogo ASANUMA, Makinohara-shi (JP); Takuomi WADA, Makinohara-shi (JP); Shun SAKAI, Makinohara-shi (JP)

(73) Assignee: Yazaki Corporation, Tokyo (JP)

(21) Appl. No.: 18/989,183

(22) Filed: Dec. 20, 2024

(30) Foreign Application Priority Data
Jan. 25, 2024 (JP) 2024-009237

(51) Int. Cl. H01M 50/507; H01M 50/519

(52) U.S. Cl. CPC H01M 50/507; H01M 50/519; H01M 2220/20

(57) ABSTRACT

The busbar module is a configuration attached to the battery cell assembly to configure the car battery together with the battery cell assembly. The busbar module includes a case with a plurality of busbar accommodation portions and an FPC accommodation portion, a plurality of busbars being accommodated in the plurality of busbar accommodation portions respectively, an FPC accommodated in the FPC accommodation portion, and an FPC cover assembled to the upper surface side of the case. The FPC cover includes a cover main body portion covering the FPC, and a busbar pressing portion to press the upper surface of the busbar to position the busbar therebetween with the busbar support portion.

### TECHNICAL FIELD

The present invention relates to a busbar module attached to a battery cell assembly.

### BACKGROUND ART

As an example of a battery mounted in a hybrid vehicle or an electric vehicle, a configuration including a battery cell assembly wherein a plurality of battery cells are stacked and a busbar module attached to the battery cell assembly is well-known (see Patent Document 1).

FIG. 9 is a view showing a conventional busbar module. A busbar module 501 shown in FIG. 9 includes a plurality of busbars 503, an FPC, a plurality of terminals 504 connected to the FPC and overlapped with the plurality of busbars 503 respectively, a case 502 accommodating these configurations, and an FPC cover 506 covering the FPC.

The busbar 503 is configured to connect electrodes of adjacent battery cells in the battery cell assembly. The battery assembly is configured that the plurality of battery cells are connected in series by the plurality of busbars 503.

The FPC is configured to connect a control unit of the battery to each battery cell via the busbar 503 and the terminal 504 for detecting a voltage of each battery cell. Beside the terminal 504, a temperature sensor for detecting the temperature of the battery cell and the like is connected to the FPC.

The case 502 is made of an insulating synthetic resin. The case 502 includes an FPC accommodation portion and a plurality of busbar accommodation portions 523. Each busbar accommodation portion 523 includes a busbar support portion 521 positioned on a bottom surface side of the busbar 503, a busbar surrounding portion 520 surrounding the busbar 503, and a claw portion 529 formed in the busbar surrounding portion 520 for fixing the busbar 503. The claw portion 529 is configured from a U-shaped slit formed in the busbar surrounding portion 520 and a protrusion protruding from a portion therebetween in the slit.

The busbar 503 is assembled to the busbar accommodation portion 523 by being inserted from the upper side of the busbar accommodation portion 523. When the busbar 503 is inserted, the claw portion 529 is pressed by the busbar 503 to rotate (bend) in a direction shown by an arrow in FIG. 9, and after the busbar 503 passes, the claw portion 529 returns to the original position to fix the busbar 503.

### CITATION LIST

### Patent Documents

[Patent Document 1] JP 2022-173610

### SUMMARY OF THE INVENTION

### Technical Problem

Regarding the above-described busbar module 501, when taking the rotation trajectory of the claw portion 529 into consideration, it is necessary to provide a gap S between the busbar support portion 521 and the busbar 503. In a case where the gap is zero, the claw portion 529 remains rotated in the direction shown by the arrow in FIG. 9 and cannot return to the original position, thus it is impossible to fix the busbar 503. In this manner, since it is necessary to provide the gap S for the busbar module 501, there is a problem where the busbar 503 rattles. Also, in the busbar module 501, it is necessary to provide the above-described gap S and a space for the claw portion 529 to rotate in the direction shown by the arrow in FIG. 9 such that there is also a problem where the case 502 becomes larger.

Therefore, the purpose of the present invention is to provide a busbar module being able to suppress the rattling of the busbar while making it possible to miniaturize the case.

### Solution to Problem

The present invention is a busbar module including a case with a busbar accommodation portion; a busbar being accommodated in the busbar accommodation portion; and a cover assembled to an upper surface side of the case, wherein the busbar accommodation portion includes a busbar support portion positioned at a lower surface side of the busbar and a busbar surrounding portion that surrounds the busbar, and the cover includes a busbar pressing portion to press an upper surface of the busbar so as to position the busbar therebetween with the busbar support portion.

### Effect of the Invention

According to the present invention, since the cover has the busbar pressing portion that presses the upper surface of the busbar to position the busbar therebetween with the busbar support portion, it is possible to suppress the rattling of the busbar and make it possible to miniaturize the case.

### BRIEF DESCRIPTION OF THE DRAWINGS

FIG. 1 is a view showing a busbar module according to an embodiment of the present invention.

FIG. 2 is an enlarged view showing a main portion of the busbar module in FIG. 1.

FIG. 3 is a cross-sectional view along the line A-A in FIG. 1.

FIG. 4 is a cross-sectional view along the line B-B in FIG. 1.

FIG. 5 is a view showing a state of removing the FPC cover in FIG. 2.

FIG. 6 is a view showing the busbar module in FIG. 5 when viewed from the upper side.

FIG. 7 is a view showing the FPC cover in FIG. 2 in a reversed up-down direction.

FIG. 8 is a view only showing the busbar in FIG. 2.

FIG. 9 is a view showing a conventional busbar module.

### DESCRIPTION OF EMBODIMENTS

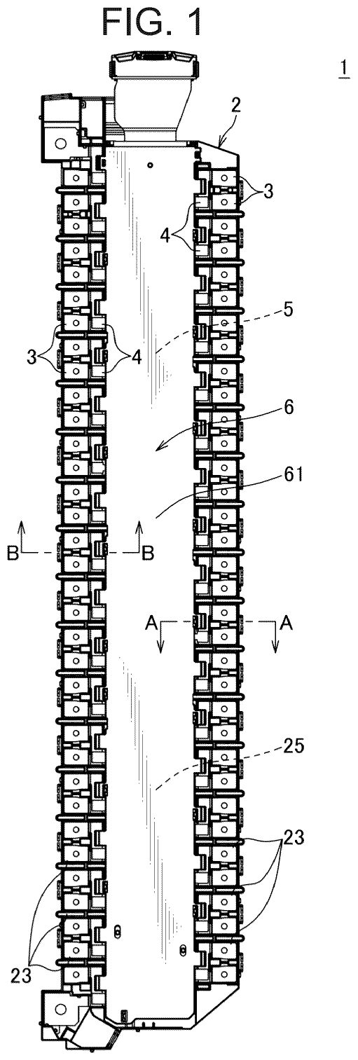

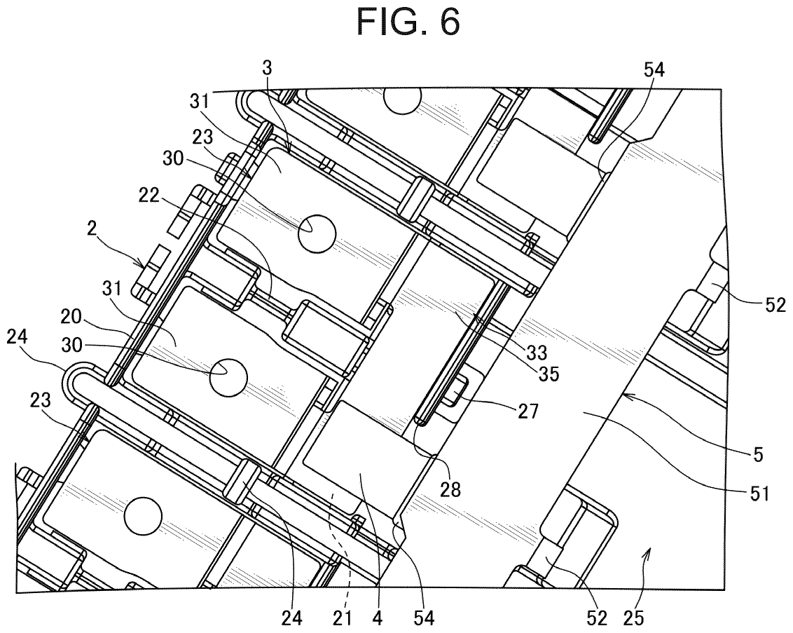

A “busbar module” according to an embodiment of the present invention will be described by referring to FIG. 1 to FIG. 8.

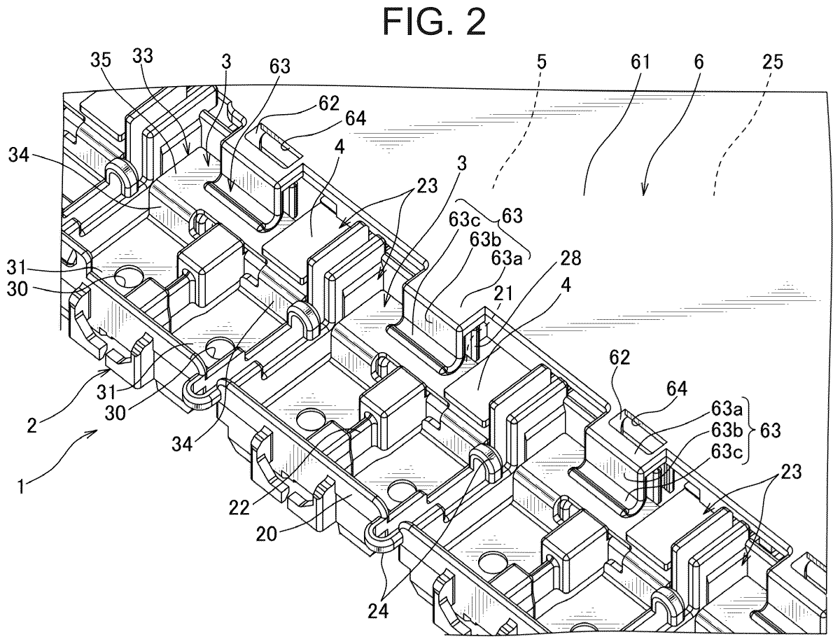

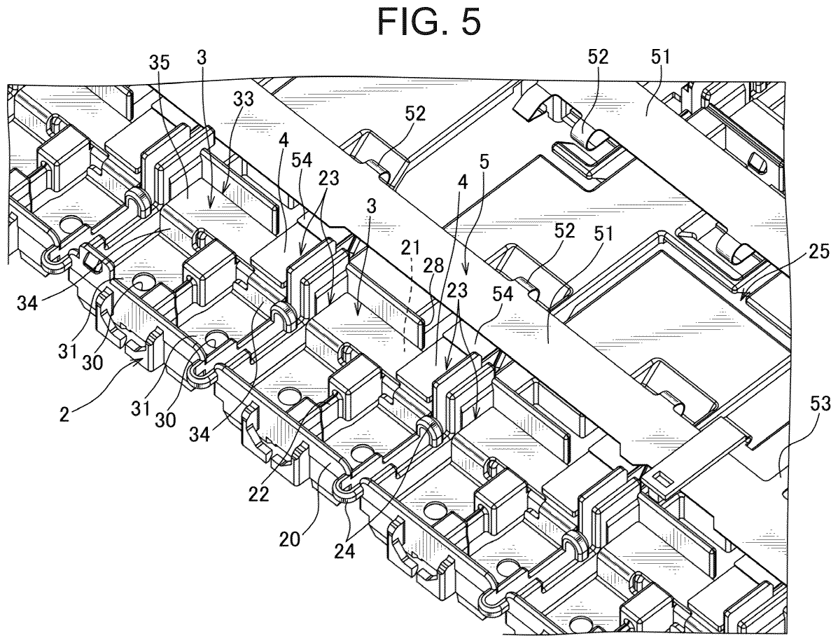

A busbar module 1 shown in FIG. 1, FIG. 2 and FIG. 5 is a configuration being attached to a battery cell assembly where a plurality of battery cells are stacked to form a car battery together with the battery cell assembly.

In the present description, regarding the busbar module 1, a side where the battery cell assembly is arranged is defined as a lower side, and a side being opposite to the battery cell assembly is defined as an upper side. Such the upper side and the lower side are not necessary to coincide with the upper side and the lower side when being actually mounted in the vehicle.

The busbar module 1 includes a plurality of busbars 3, FPC (Flexible Printed Circuits) 5, a plurality of terminals 4, a plurality of temperature sensors (being omitted in figures), a case 2 for accommodating these configurations, and an FPC cover 6.

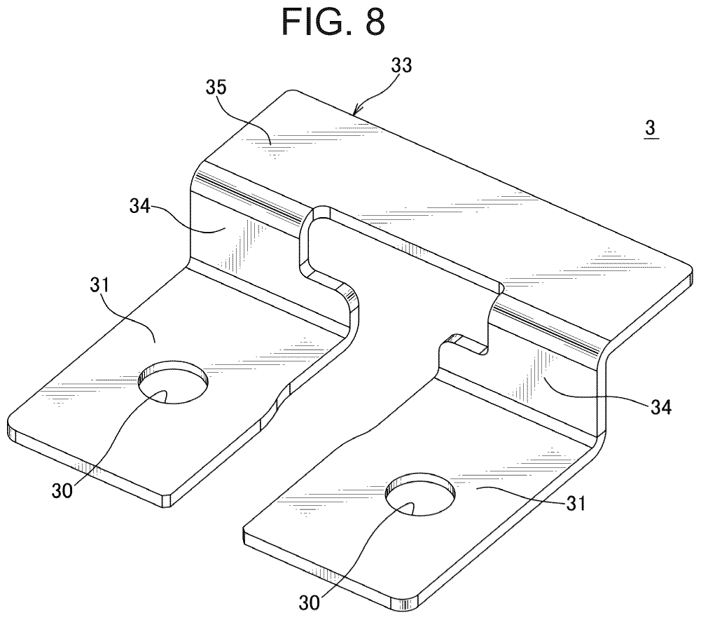

The busbar 3 is a configuration for connecting electrodes of the adjacent battery cells of the battery cell assembly. The battery cell assembly is configured wherein the plurality of battery cells are connected in series by the plurality of busbars 3. The busbar 3 is achieved by performing the press processing or the like with respect to a metal plate, and as shown in FIG. 8, the busbar 3 includes a pair of electrode connection portions 31 being apart from each other with a gap therebetween, and a connection portion 33 for connecting the pair of electrode connection portions 31.

In each electrode connection portion 31, a hole 30 for the electrode of the battery cell to pass through is formed. The connection portion 33 includes a pair of vertical portions 34 standing up from sides of the pair of electrode connection portions 31 respectively, and a horizontal portion 35 connecting the pair of vertical portions 34. The boundary portions between the pair of vertical portions 34 and the horizontal portion 35 are bent at the right angles respectively.

As shown in FIG. 5, the FPC 5 includes a pair of trunk wire portions 51 each extending to be parallel to each other, a first connection portion 53 connecting the pair of trunk wire portions 51, a plurality of branch portions 54 being disposed at the lower side of the trunk wire portions 51, and a plurality of second connection portions 52 connecting each branch portion 54 with the trunk wire portion 51 respectively.

Although it is omitted from the figures, the FPC 5 further includes a plurality of third connection portions connecting a plurality of temperature sensors with the trunk wire portions 51 respectively. The plurality of temperature sensors come into contact with predetermined battery cells respectively so as to detect the temperature of the corresponding battery cells. In the present example, there are three temperature sensors being provided to come into contact with the battery cells disposed at one end, the other end, and a central portion of the battery cell assembly, respectively.

The pair of trunk wire portions 51 are extending in a longitudinal direction of the case 2. The longitudinal direction of the case 2 and the longitudinal direction of the trunk wire portions 51 coincide with a direction in which the battery cells of the battery cell assembly are stacked. The terminal 4 is connected to each branch portion 54. The branch portion 54 and the terminal 4 are provided per each battery cell. The second connection portion 52 is bent in a U-shape.

The FPC 5 is connected to a control unit disposed at one end side of the car battery. In the FPC 5, the wiring patterns connecting the control unit and each terminal 4, and the wiring patterns connecting the control unit and each temperature sensor are formed. The busbar module 1 according to the present example detects the voltage of each battery cell, the total voltage, and the temperature of specified battery cell and the control unit monitors these voltages and the temperatures.

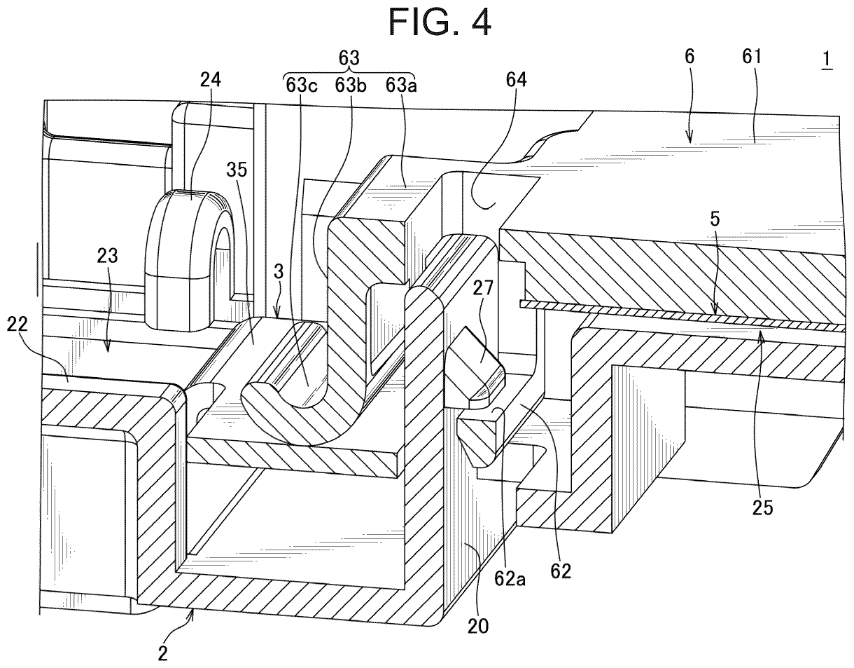

As shown in FIG. 4 and FIG. 5, the plurality of terminals 4 are formed in a plate shape, wherein one end side thereof are overlapped with the branch portions 54 of the FPC 5 to be electrically and mechanically connected thereto, and the other end side are overlapped with the horizontal portion 35 of the busbar 3 to be electrically and mechanically connected thereto.

The case 2 is made of an insulating synthetic resin. The case 2 integrally includes an FPC accommodation portion 25, a plurality of busbar accommodation portions 23, and a connection portion 24 connecting the adjacent busbar accommodation portions 23.

The FPC accommodation portion 25 is a portion for accommodating the above-described FPC 5. The FPC accommodation portion 25 is formed in a central portion in the width direction of the case 2 while in the whole area in the longitudinal direction of the case 2.

The busbar accommodation portion 23 is a portion for accommodating the above-described busbar 3. One busbar 3 is accommodated in one busbar accommodation portion 23. The plurality of busbar accommodation portions 23 are formed in the end portions in the width direction of the case 2 while at both sides of the FPC accommodation portion 25. Also, the plurality of busbar accommodation portions 23 are lined up in the longitudinal direction of the case 2, wherein the adjacent busbar accommodation portions 23 are connected by the connection portion 24.

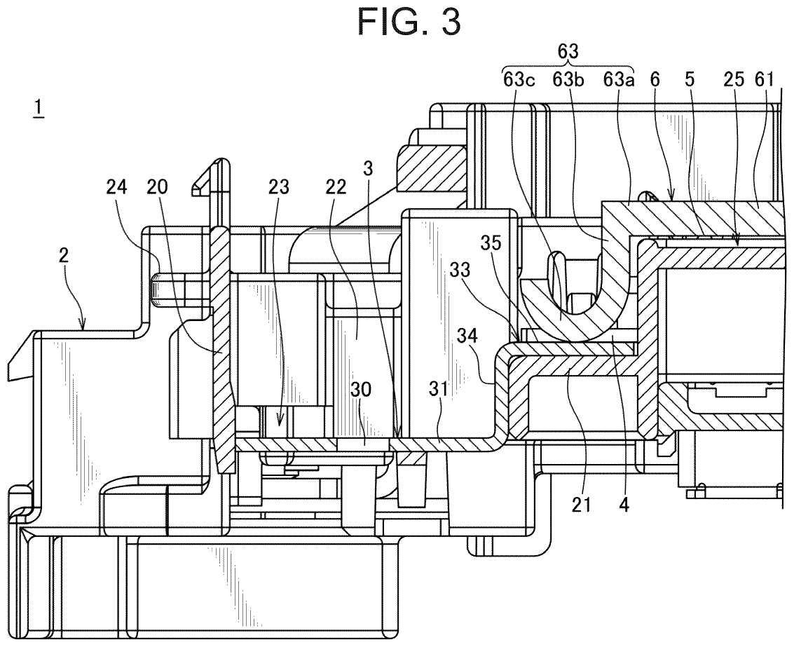

As shown in FIG. 2 and FIG. 3, each busbar accommodation portion 23 includes the busbar support portion 21 positioned at the lower surface side of the horizontal portion 35 of the busbar 3, the busbar surrounding portion 20 surrounding the whole busbar 3, and a partition 22 positioned between the pair of electrode connection portions 31 of the busbar 3.

The busbar support portion 21 is connected with the FPC accommodation portion 25 and the busbar surrounding portion 20. The lower surface side of the pair of electrode connection portions 31 are provide with none of wall of the case 2 or the like such as the busbar support portion 21 so as to be open. The electrode of the battery cell is passed through this opening and the hole 30 of the electrode connection portion 31, and a nut is fastened thereto.

The busbar surrounding portion 20 is formed in a frame shape surrounding the whole busbar 3, and in the boundary portion with the FPC accommodation portion 25, a notch portion 28 for passing through the terminal 4 is formed. Also, in the boundary portion with the FPC accommodation portion 25 of the busbar surrounding portion 20, a locking protrusion 27 protruding toward the FPC accommodation portion 25 side is formed.

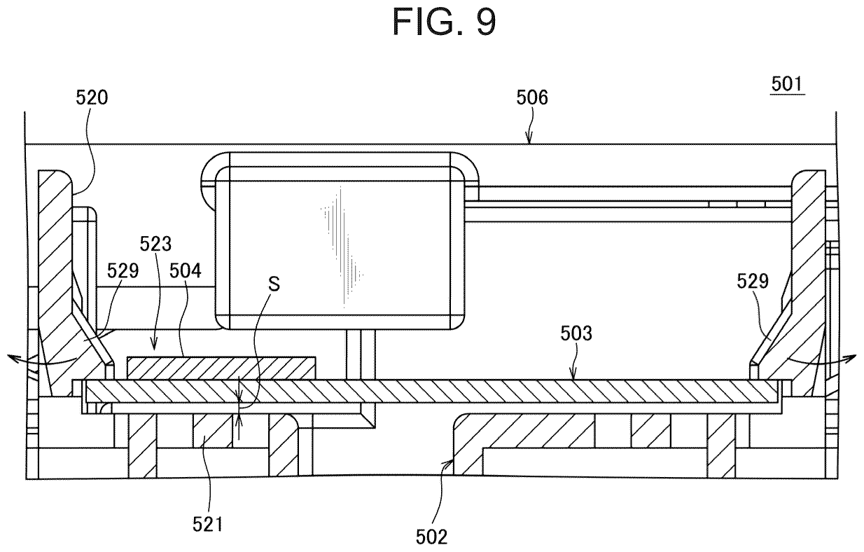

The busbar 3 is inserted into the busbar accommodation portion 23 from the upper side (the opposite side with respect to the battery cell assembly) of the busbar accommodation portion 23. With respect to the inserted busbar 3, since the busbar surrounding portion 20 is positioned in the circumference thereof, and the busbar support portion 21 is positioned at the lower surface side thereof, the movement of the electrode connection portion 31, in the surface direction and toward the lower side, is restricted. On the other hand, in the busbar accommodation portion 23, a structure for fixing the busbar 3 (the claw portion 529 in FIG. 9) is not provided such that in a state in which the FPC cover 6 is not attached to the case 2, the movement toward the upper side is allowed. This movement toward the upper side is restricted by the busbar pressing portion 63 provided in the FPC cover 6.

The FPC cover 6 is made of an insulating synthetic resin. The FPC cover 6 is assembled with the upper surface side of the case 2. The FPC cover 6 integrally includes a cover main body portion 61 that is positioned at the upper surface side of the FPC 5 to position the FPC 5 therebetween with the FPC accommodation portion 25, a plurality of locking portions 62, and a plurality of busbar pressing portions 63.

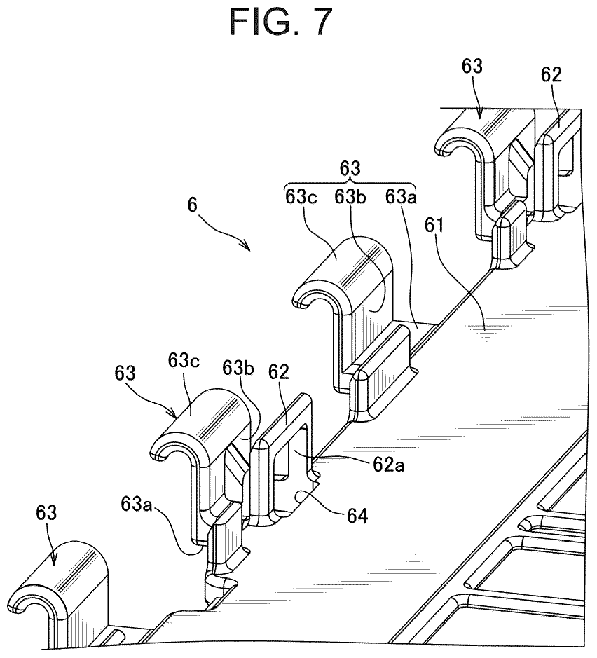

As shown in FIG. 1, the cover main body portion 61 is formed in a narrow elongated plate shape. As shown in FIG. 4 and FIG. 7, the plurality of locking portions 62 hang down from end portions in the width direction of the cover main body portion 61, and each having a locking hole 62a. Each locking portion 62 is locked to each locking protrusion 27 formed in the case 2. Accordingly, the FPC cover 6 is assembled to the case 2.

The plurality of busbar pressing portions 63 include an extending portion 63a extending outwardly from the end portion of the cover main body portion 61 in the width direction, a plate portion 63b hanging down from the end portion of the extending portion 63a that is apart from the cover main body portion 61, and a tip end portion 63c being bent in a hook shape to be continuous with the lower end of the plate portion 63b.

The busbar pressing portion 63 positions the horizontal portion 35 therebetween with the busbar support portion 21 by the tip end portion 63c pressing the upper surface of the horizontal portion 35 of the busbar 3. In this manner, the movement of the busbar 3 toward the upper side, that is, the lifting thereof is restricted.

Also, the above-described locking portion 62 is formed in the vicinity of the busbar pressing portion 63 to face the plate portion 63b. Therefore, in the extending portion 63a, an opening 64 being necessary for molding the locking portion 62 is formed. Also, a number of the locking portions 62 is smaller than that of the busbar pressing portions 63 such that there are busbar pressing portions 63 where the openings 64 are not formed.

The claw shape provided in the case of the conventional busbar module is removed in the above-described busbar module 1, and the fixation between the busbar 3 and the case 2 is performed by the pressing due to the FPC cover 6 rather than the fixation using the claw. More specifically, the busbar pressing portion 63 is provided in the FPC cover 6 so as to realize the configuration of pressing the busbar 3 from the upper side to fix utilizing the flexibility of the resin.

With regard to such busbar module 1, the gap (gap S in FIG. 9) between the case and the busbar which is considered to be necessary for the fixation by the conventional claw becomes unnecessary and it is possible to fix the busbar 3 without any rattling. Also, the resin has the flexibility such that the force of pressing the busbar 3 toward the busbar support portion 21 works such that it is possible to fix without any rattling even if the gap is generated due to the tolerance of the busbar 3 and the case 2. Accordingly, the capability of easily performing the assembling to the battery cell assembly is improved. Also, the gap between the case 2 and the busbar 3 is removed such that the height of the busbar accommodation portion 23 can be lower than that of the conventional product, and furthermore the space for rotating the claw can also be eliminated, thus it is possible to miniaturize the case 2 and the busbar module 1. Furthermore, by removing the claw shape, it leads to the cost down of the case 2. Furthermore, by removing the claw shape, the strength of each busbar accommodation portion 23 is increased.

It is noted that the above-described embodiment merely shows a typical aspect of the present invention, and the present invention is not limited to this embodiment. That is, various modifications can be made without departing from the scope of the invention. Of course, such modifications will fall within the scope of the present invention as long as they still have the configurations according to the present invention.

### REFERENCE SIGNS LIST

1 busbar module
2 case
3 busbar
4 terminal
5 FPC
6 FPC cover (cover)
20 busbar surrounding portion
21 busbar support portion
23 busbar accommodation portion
25 FPC accommodation portion
27 locking protrusion
61 cover main body portion
62 locking portion
63 busbar pressing portion

What is claimed is:

1. A busbar module, comprising:
a case with a busbar accommodation portion;
a busbar being accommodated in the busbar accommodation portion; and
a cover assembled to an upper surface side of the case,
wherein the busbar accommodation portion includes a busbar support portion positioned at a lower surface side of the busbar and a busbar surrounding portion that surrounds the busbar, and
the cover includes a busbar pressing portion to press an upper surface of the busbar so as to position the busbar therebetween with the busbar support portion.

2. The busbar module according to claim 1, wherein a tip end portion of the busbar pressing portion is bent in a hook shape.

3. The busbar module according to claim 1,
wherein the case includes an FPC accommodation portion,
the busbar module further comprises an FPC being accommodated in the FPC accommodation portion, and
the cover includes a cover main body portion being positioned at the upper surface side of the FPC to position the FPC therebetween with the FPC accommodation portion.
